(19) United States
(12) Patent Application Publication
(10) Pub. No.: US 2002/0116189 A1
(43) Pub. Date: Aug. 22, 2002

(54) Method for identifying authorized users using a spectrogram and apparatus of the same

(75) Inventors: Tsuei-Chi Yeh, Hsinchu (TW); Wen-Yuan Chen, Hsinchu (TW)

Correspondence Address: Richard P. Berg, Esq., c/o LADAS & PARRY, 5670 Wilshire Boulevard, Suite 2100, Los Angeles, CA, 90036-5679, US

(73) Assignee: Winbond Electronics Corp.

(21) Appl. No.: 09/884,287

(22) Filed: Jun. 19, 2001

(30) Foreign Application Priority Data
Dec. 27, 2000 (TW) 89128026

(51) Int. Cl. G10L 17/00

(52) U.S. Cl. 704/248

(57) ABSTRACT

A method for identifying authorized users and the apparatus of the same, which identifies users by comparison with specific spectrograms of authorized users. The method comprises the steps of: (i) detecting the end point of a verbalized sample from the user requesting access; (ii) retrieving speech features from a spectrogram of the speech; (iii) determining whether training is necessary, and if so, taking the speech features as a reference template, setting a threshold and going back to (i), otherwise going on to next step; (iv) matching patterns of the speech features and the reference template; (v) computing a distance between the speech features and the reference template according to the matching result of (iv) to obtain a distance scoring; (vi) comparing the distance scoring with the threshold; (vii) determining whether the user is authorized according to the compared result of (vi).

### BACKGROUND OF THE INVENTION

1. Field of the Invention

The present invention relates to speech identification, especially to a method for identifying an authorized user using a spectrogram and the apparatus of the same.

1. Description of the Related Art

With the development of communications technology, mobile phones have become extremely popular. However, there exist numerous problems regarding the security of mobile phones. For example, an unauthorized user may use a mobile phone without any permission, thus causing a loss of the phone's owner.

To prevent a mobile phone from being used by an unauthorized user, a Personal Identification Number (PIN) is normally provided. The user is required to enter a password when the mobile phone is turned on. The user can use the mobile phone only when the submitted password is correct. However, this way is troublesome since it requires the user to remember their password. Once the user forgets the password or enters an incorrect password, the mobile phone locks and the user is unable to use it. Furthermore, since an unauthorized user may still get the password, the PIN system fail to fully meet the requirements of mobile phone security.

In order to overcome the shortcomings of the above-described method, some prior arts use speech identification technology to identify authorized users. For example, in U.S. Pat. No. 5,913,196, at least two voice authentication algorithms are used to analyze the voice of a speaker. Furthermore, in U.S. Patent No. 5,499,288, heuristically-developed time domain features and spectrum information such as FFT (Fast Fourier Transform) coefficients are retrieved from the voice of a speaker. Then, the second and third features are determined based on the primary feature. These features are applied to the speech identification process. In U.S. Pat. No. 5,216,720, LPC (Linear Predictive Coding) analysis is used to obtain the speech features. Moreover, DTW (Dynamic Time Warping) is used to score the distance of submitted speech features and reference speech features.

To practice the above prior arts requires a complex and unwieldy hardware structure. The prior arts are not, therefore, feasibly applied to mobile phone technology.

### SUMMARY OF THE INVENTION

Accordingly, in order to overcome the drawbacks of the prior arts, an object of the present invention is to provide a method for identifying an authorized user and an apparatus of the same, which identifies a user based on the specific spectrogram of various users to determine whether the user is authorized.

Since an inherent difference exists between individuals in the way they speak and vocal physiology, such as the structure of the vocal region, the size of the nasal cavity and the feature of the vocal cords, the speech of each person contains numerous unique characteristics. The invention extracts this unique information from speech by using spectrogram analysis to identify users.

According to the present invention, the user is first asked to vocalize a spoken password. An endpoint detection algorithm is applied to detect the beginning and end points of the speech. As the speech is analyzed, the modified discrete Cosine transformation (MDCT) is used to transform the time domain information into frequency domain to create the spectrogram for the received speech. A fixed dimension feature vector is computed from the spectrogram. If this vocalization is regarded as a training template, it will be stored in a memory device such as a RAM and accessed as a reference template. Otherwise, the item is regarded as a testing template to identify whether the speaker is authorized. A pattern matching procedure is introduced to compare the testing template and the reference template. Similarity can be measured by a distance computation. Based on the resulting distance, an acceptance or rejection command from the apparatus of this invention can be generated.

### BRIEF DESCRIPTION OF THE DRAWINGS

The present invention can be more fully understood by reading the subsequent detailed description in conjunction with the examples and references made to the accompanying drawings, wherein:

FIG. 1 is a diagram illustrating the method for identifying the authorized user of a telephone according to this invention;

FIG. 2 is a block diagram of the apparatus for analyzing speech according to this invention;

FIG. 3 is a diagram illustrating the pre-emphasis process according to this invention;

FIG. 4 is a diagram illustrating the process for determining a short-time majority magnitude according to this invention;

FIG. 5 is a diagram illustrating the process for detecting the end point according to this invention;

FIG. 6 is a diagram illustrating the method for extracting the speech features from the spectrogram according to this invention;

FIG. 7 is a block diagram of the apparatus for identifying the authorized user using a spectrogram according to this invention.

### DETAILED DESCRIPTION OF THE PREFERRED EMBODIMENT

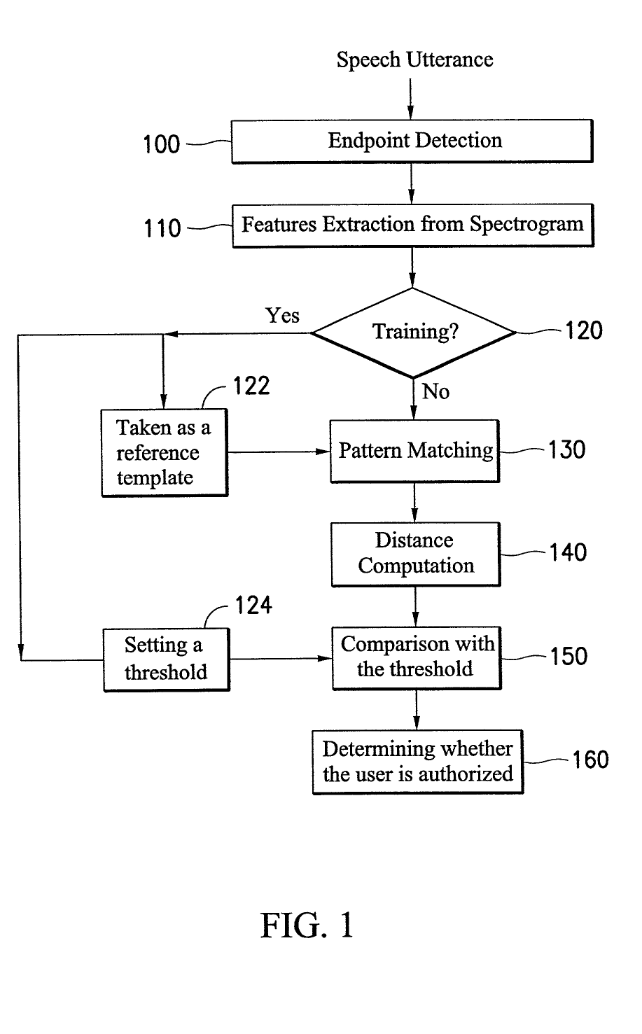

This embodiment is described with regard to the user of a mobile phone. Refer to FIG. 1, the method for identifying the authorized user of a telephone according to this invention includes the steps of: (i) step 100, detecting the end point of a speech after the user speaks; (ii) step 110, extracting the speech features from the spectrogram of the speech; (iii) step 120, determining whether training is needed, if yes, then going to step 122, taking the speech features as a reference template and going to step 124 to set a threshold, and then going back to the step 100, otherwise going to the next step; (iv) step 130, matching the patterns of the speech features and the reference template; (v) step 140, computing the distance between the speech features and the reference template based on the compared result of the step 130 to obtain the distance scoring; (vi) step 150, comparing distance scoring with the threshold; (vii) step 160, determining whether the user is authorized according the compared result of the step 150.

Next, each step is further explained.

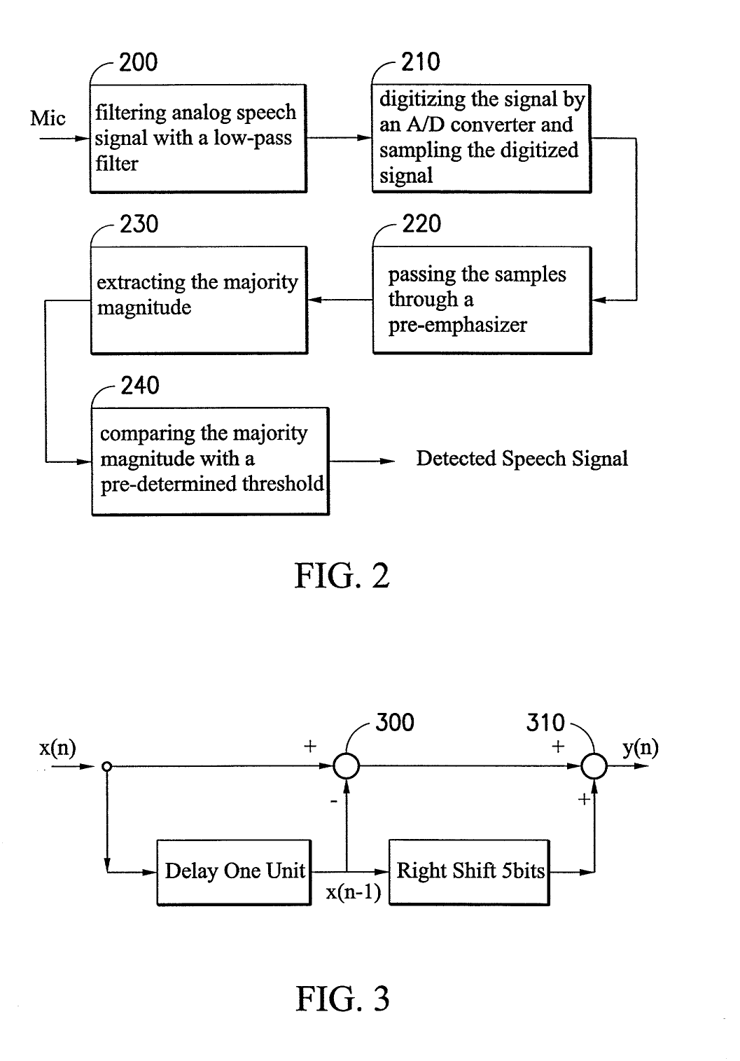

Referring to FIG. 2, the process for detecting the end point of a speech includes the steps of: (i) step 200, filtering the analog speech signal with a low-pass filter; (ii) step 210, the signal output from the low-pass filter is digitized by an A/D converter and then the digitized signal is sampled at a rate of 8 kHz with 8-bit resolution; (iii) step 220, passing the samples through a pre-emphasizer to thoroughly model both the lower-amplitude and the higher-frequency parts of the speech; (iv) step 230, extracting the majority magnitude to describe the characteristic of amplitude; (v) step 240, comparing the majority magnitude of each frame and a pre-determined threshold to determine the beginning and end points of the speech.

In the step 200, the frequency limitation of the low-pass filter is 3500 Hz.

In this embodiment, since the pre-emphasizing factor α is selected to be 31/32, the pre-emphasizing process can be achieved by the following equation:

y(n)=x(n)−αx(n−1)=x(n)−(31/32)×(n−1)=x(n)−x(n−1)+x(n−1)/32

The process of pre-emphasizing the digital data in step 220 is as shown in FIG. 3. Wherein x(n) and y(n) are digitized data, reference numeral 300 indicates a subtraction operation and reference numeral 310 indicates an addition operation.

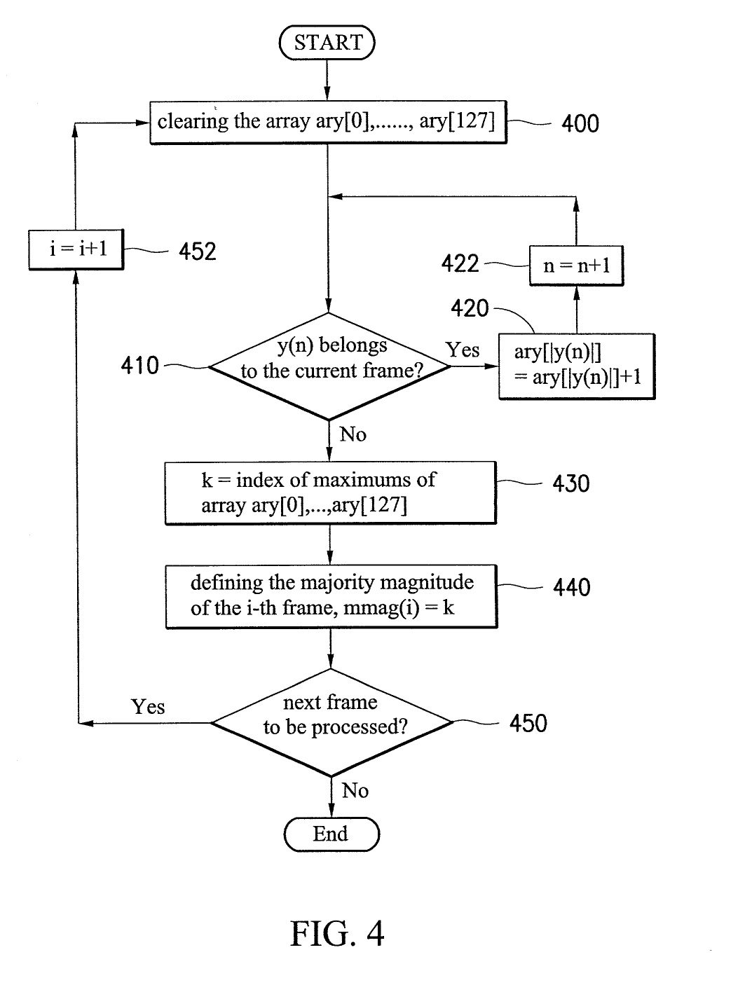

The pre-emphasized speech data is divided into frames. Each frame contains 160 samples (i.e., 20 millisecond). The parameter called majority magnitude obtained in the step 230, is extracted to describe the characteristic of the amplitude. Referring to FIG. 4, the process of obtaining the majority magnitude includes the steps of: (i) step 400, clearing the array ary[0], . . . , ary[127]; (ii) step 410, determining whether the digitized data y(n) belongs to the current frame, if yes going to the next step, otherwise going to step 430; (iii) step 420, updating the array ary[|y(n)|] of y(n), in which ary[|y(n)|]=ary[|y(n)|]+1; (iv) step 422, going on the next digitized data so that n=n+1, and then going back to the step 410; (v) step 430, obtaining the index value k of the maximums of the array ary[0], . . . , ary[127] for each digitized data; (vi) step 440, defining the majority magnitude of the i-th frame, mmag(i)=k; (vii) step 450, determining whether there is a next frame to be processed, if yes going to the next step, otherwise going to the end; (viii) step 452, performing the calculation of next frame and letting i=i+1, then going back to the step 400.

In the process of extracting the majority magnitude, the total number of each absolute amplitude level is counted. The great majority of absolute amplitude levels is defined as the majority magnitude of current frame. The majority magnitude is used in this invention to replace the traditional energy for saving the computation power.

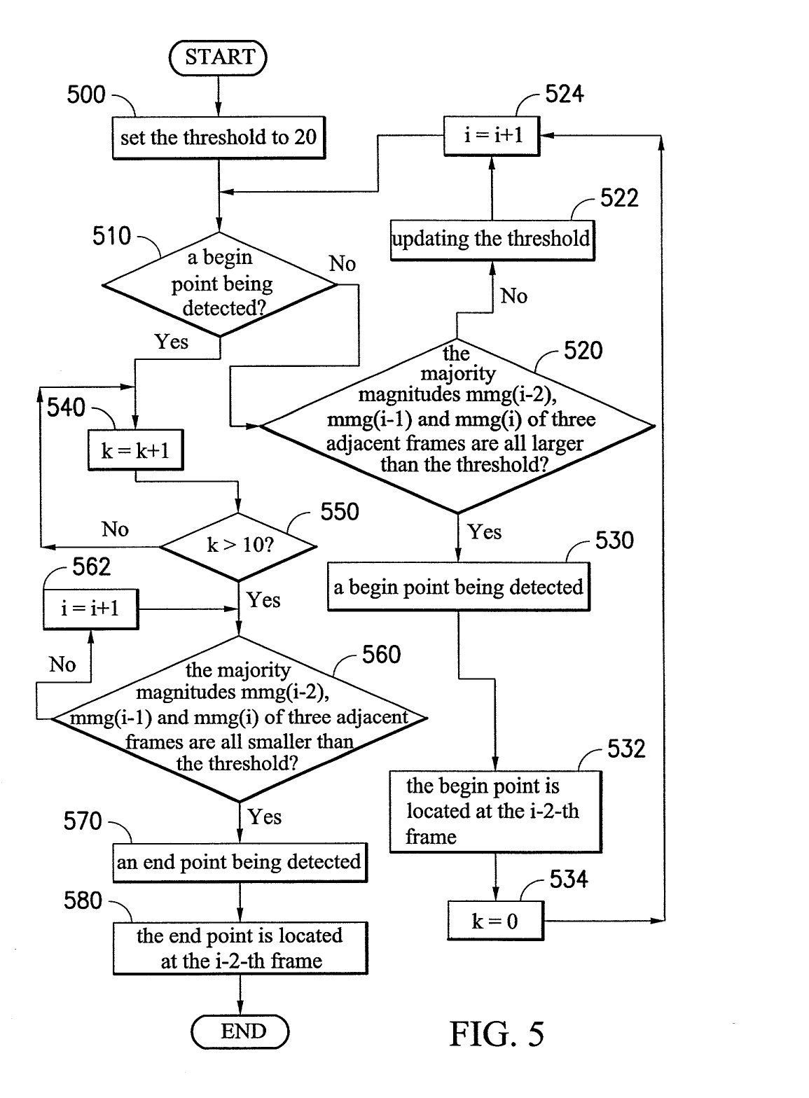

Referring to FIG. 5, the process for determining the beginning and end points of a speech in the step 240 includes the steps of: (i) step 500, initially setting the threshold to 20; (ii) step 510, determining whether there is a begin point being detected, if yes going to step 540, otherwise going to the next step; (iii) step 520, determining whether the majority magnitudes mmg(i−2), mmg(i−1) and mmg(i) of three adjacent frames are all larger than the threshold, if yes going to step 530, otherwise going to the next step; (iv) step 522, updating the threshold; (v) step 524, letting i=i+1 and then going back to the step 510; (vi) step 530, a begin point being detected; (vii) step 532, determining that the begin point is located at the i−2-th frame; (viii) step 534, letting k=0 and then going to the step 524; (ix) step 540, letting k=k+1; (x) step 550, determining whether k is larger than 10, if yes going to the next step, otherwise going to the step 540; (xi) step 560, determining whether the majority magnitudes mmg(i−2), mmg(i−1) and mmg(i) of three adjacent frames are all smaller than the threshold, if yes going to step 570, otherwise going to the next step; (xii) step 562, letting i=i+1 and then going back to the step 560; (xiii) step 570, an end point being detected; (xiv) step 580, determining that the end point is located at the i−2-th frame and going to the end.

In the above process of detecting the end point, the threshold of the background noise is initially set to 20. The majority magnitude is extracted for each frame. The majority magnitude is then compared with the preset threshold to determine whether the frame is a part of the speech. It indicates that the begin point of the speech is detected if the majority magnitudes of three adjacent frames are all larger than the threshold. Otherwise, the frame is regarded as a new event of background noise and the threshold is updated. The update procedure is carried out by the following equations.

$$\begin{matrix}new\_threshold = ( old\_threshold \times 31 + new\_input ) \div 32 \\ = ( old\_threshold \times 32 - old\_threshold + new\_input ) \div 32 \\ = old\_threshold + ( new\_input - old\_threshold ) \div 32\end{matrix}$$

The division can be implemented by a shifting operation. Moreover, based on the assumption that there is at least a 300-millisecond duration for a single sample, the detection of the end point starts 10 frames after the beginning frame. It indicates that the end point of the speech is detected if the majority magnitudes of three adjacent frames are all smaller than the threshold.

In order to retrieve the speech features from the spectrogram, a Princen-Bradley filter bank is used to transform the detected speech signal to get its corresponding spectrogram in this embodiment. The Princen-Bradley filter bank is disclosed in “Analysis/Synthesis Filter Bank Design Based On Time Domain Aliasing Cancellation,” IEEE Trans. on Acoustics, Speech, and Signal Processing, Vol. ASSP-34, No. 5, October 1986, pp. 1153-1161, by John P. Princen and Alan Bernard Bradley.

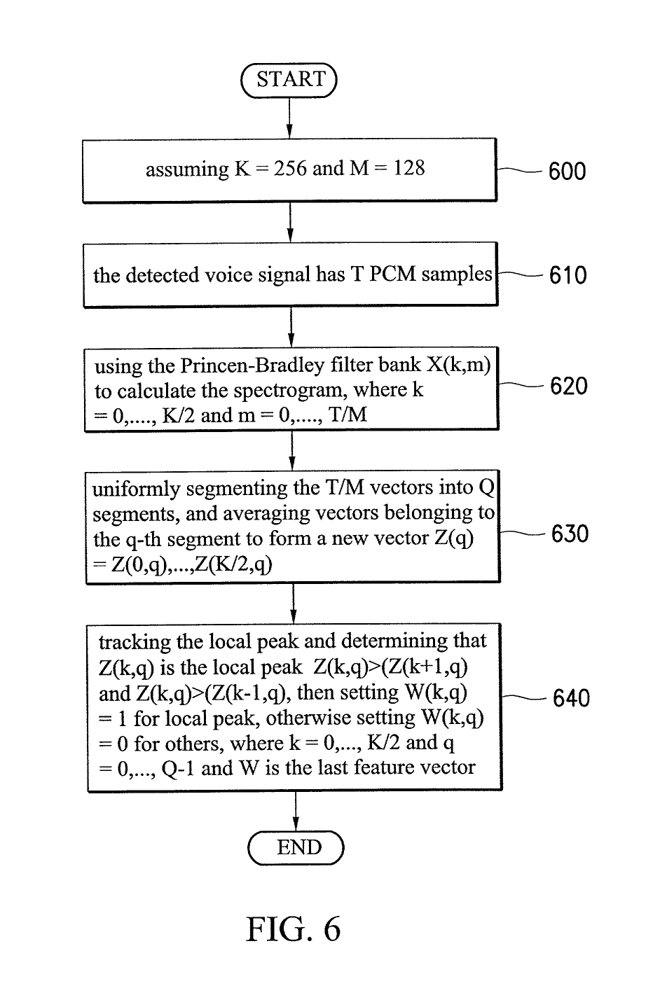

Referring to FIG. 6, the process of retrieving the speech features from the spectrogram includes the steps of: (i) step 600, assuming the frame length K=256 and the frame rate M=128; (ii) step 610, dividing the detected voice signal into T PCM (Pulse Code Modulation) samples x(n), where n=0, . . . , T−1; (iii) step 620, using the Princen-Bradley filter bank X(k,m) to calculate the spectrogram, where k=0, . . . , K/2 and m=0, . . . , T/M; (iv) step 630, uniformly segmenting the T/M vectors into Q segments, and averaging vectors belonging to the q-th segment to form a new vector Z(q)=Z(0,q), . . . , Z(K/2,q); (v) step 640, tracking the local peak and determining that Z(k,q) is the local peak if Z(k,q)>Z(k+1,q) and Z(k,q)>Z(k−1, q), then setting W (k,q)=1 for local peak, otherwise setting W(k,q)=0 for others, where k=0, . . . , K/2 and q=0, . . . , Q-1 and W is the last feature vector, and going to the end.

In the above-described process of retrieving speech features from the spectrogram, the Princen-Bradley filter bank is applied to transform the detected speech signal into its corresponding spectrogram. Assume that a frame has K PCM samples, and the current frame has M PCM samples overlapped with the next frame. In this embodiment, K and M are respectively set to 256 and 128. Thus, the k-th band signal of the m-th frame can be calculated by the following equation.

Y(k,m)=Σy(n)h(mM−n+K−1)cos(mπ/2−2π(n+n0)/K)

Coefficients of the window h( ) can be found in the Table XI of the above-described Princen and Bradley paper. Y(m)=Y(0,m), . . . Y(K/2,m) cover the frequency ranges over 0 Hz to 4000 Hz. If the detected speech has a total of T PCM samples, L(=T/M) vectors of Y(m) is calculated to represent the spectrogram of these T PCM samples. The L vectors Y(m) are then uniformly segmented into Q segments. Vectors belonging to the q-th segment are averaged to form a new vector Z(q)=Z(0,q), . . . , Z(K/2,q). Thereafter, A local peak tracking subroutine is performed to mark the local peaks by setting W(k,q)=1 for local peak and setting W(k,q)=0 for others. A pattern having Q(K/2+1) bits is thus obtained to represent the spectrogram of the detected speech.

Next, pattern matching and distance computation are initiated. The distance scoring dis between the reference template RW which is made of RW(0), . . . , RW(Q) and the testing template TW which is made of TW(0), . . . , TW(Q) is calculated by the following equation.

dis=Σ|TW(i,j)−RW(i,j)|, where i=0, . . . , K/2 and j=0, . . . , Q.

Since the value of TW(i,j) and RW(i,j) is either 1 or 0, implementation of the above equation can be easily worked out by a bit operation. The threshold value in FIG. 1 is pre-determined by an authorized user. If the value dis obtained from the above equation does not exceed the threshold, an acceptance command is sent.

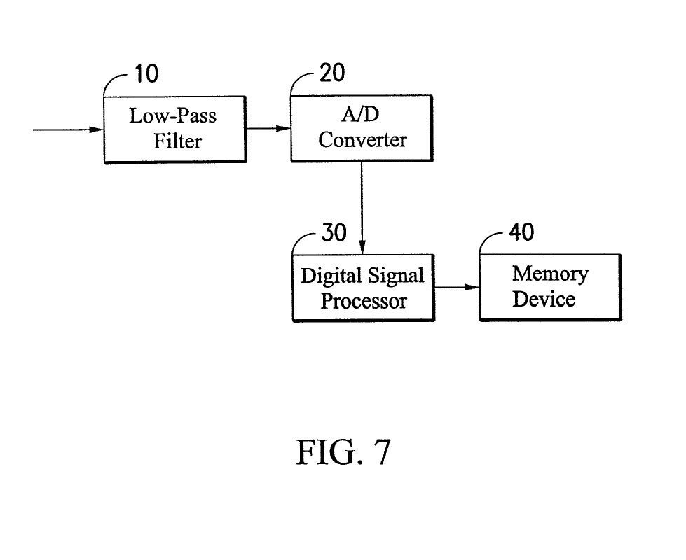

Referring to FIG. 7, the apparatus to identify authorized users by using spectrogram includes a low-pass filter 10, an A/D converter 20, a digital signal processor 30 and a memory device 40.

The low-pass filter 10 is used to limit the frequency range of the submitted speech.

The A/D converter 20 is used to convert the analog signal of submitted speech to a digital signal.

The digital signal processor 30 is used to receive the digital signal from the A/D converter 20 and implements the operations in each step of FIG. 1.

The memory device 40 is used to store the data of the threshold and the reference template, which are required in the operations of the digital signal processor 30.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for identifying an authorized user using a spectrogram includes the steps of:
(i) detecting an end point of a speech after a user speaks;
(ii) extracting speech features from a spectrogram of the speech;
(iii) determining whether training is necessary, and, if so, taking the speech features as a reference template, setting a threshold and going back to (i), otherwise, proceeding to the next step;
(iv) matching patterns of the speech features and the reference template;
(v) computing a distance between the speech features and the reference template according to a matching result of (iv) to obtain a distance scoring;
(vi) comparing the distance scoring with the threshold;
(vii) determining whether the user is authorized according to a compared result of (vi).

2. The method as claimed in claim 1 wherein the detection of the end point of the speech in (i) includes the steps of:
(i) filtering the speech with a low-pass filter;
(ii) converting analog speech signals to digital speech signals by an A/D converter;
(iii) pre-emphasizing the digital speech signals to thoroughly model lower-amplitude and higher-frequency parts of the speech;
(iv) extracting a majority magnitude for each frame;
(v) comparing the majority magnitude of each frame with the threshold to determine a begin point and an end point of the speech.

3. The method as claimed in claim 1 wherein the speech features are retrieved by using a Princen-Bradley filter bank to transform the detected speech signal to obtain a corresponding spectrogram.

4. The method as claimed in claim 2 wherein the majority magnitude is obtained by counting the total number of each absolute amplitude level, and the great majority of the absolute amplitude levels is defined as the majority magnitude of the current frame.

5. The method as claimed in claim 2 wherein the process of determining the begin point and the end point of the speech in the step (v) includes the steps of:
(i) setting a threshold;
(ii) determining whether the detection of the begin point is beginning, if yes going to step (iv), otherwise going to next step;
(iii) determining whether the majority magnitudes of three adjacent frames are all larger than the threshold, if not, then changing the threshold and going on to the measurement of the next majority magnitude and going back to step (ii), otherwise the beginning point having been detected, going on to the measurement of the next majority magnitude and going back to step (ii);
(iv) delaying a period of time;
(v) determining whether the majority magnitudes of three adjacent frames are all smaller than the threshold, and, if not, going on the measurement of the next majority magnitude and going back to step (v), otherwise the end point has been detected.

6. An apparatus for identifying an authorized user by using spectrograms comprising:
a low-pass filter for limiting the frequency range of submitted speech.
an A/D converter for converting analog speech signals to digital speech signals.
a digital signal processor for receiving digital speech signals from the A/D converter and performing operations in each step of the method as claimed in claim 1; and
a memory device for storing data of a threshold and a reference template which are required in the operations of the digital signal processor.
